(19) United States
(12) Patent Application Publication
(10) Pub. No.: US 2008/0238687 A1
(43) Pub. Date: Oct. 2, 2008

(54) Secure RFID device

(75) Inventors: Yaacov Ozer, Wan Chai (HK); Benzion Torem, Mitzpe Hoshaya (IL); Israel Schneiderman, Jerusalem (IL)

Correspondence Address: Martin D. Moynihan;PRTSI, Inc., P.O. Box 16446, Arlington, VA, 22215, US

(73) Assignee: Rosslare Enterprises Ltd., Kowloon Bay (HK)

(21) Appl. No.: 11/727,717

(22) Filed: Mar. 28, 2007

(51) Int. Cl. G08B 13/14

(52) U.S. Cl. 340/572.7

(57) ABSTRACT

An RFID device comprises a device body and an antenna integrally located thereon. The device comprises a metallic chassis about the body, the antenna is spaced by at least one millimeter from the metallic chassis, and the antenna is tuned to achieve resonance at a desired operating frequency at the integral location. That is to say tuning is adjusted to take account of a change in inductance due to the proximity of the metallic chassis. Use of metal in the chassis makes the device more secure, whether against vandalism or against the elements.

### FIELD AND BACKGROUND OF THE INVENTION

The present invention relates to a secure RFID device and, more particularly, but not exclusively to an RFID reader device that is suitable for outdoor use, in that it is more secure than existing devices against vandalism and crime or against the elements.

Radio Frequency Identification (RFID) uses radio frequency (RF) electromagnetic waves to identify objects carrying identifying transponders. Each RFID system consists of one or more RFID readers and, usually, many transponders. During its normal operation, the RFID reader transmits an electromagnetic wave to excite a target transponder. The transponder responds to the excitation by selectively reflecting that electromagnetic wave, thereby causing an electromagnetic field disturbance. The field disturbance is interpreted by the RFID reader to reveal the transponder identity and other preprogrammed information stored in the transponder. The process of selectively reflecting the illuminating electromagnetic waves by changing the energy absorption characteristic of the transponder, thereby creating a field disturbance that can be sensed by the reader's antenna, is a process known as backscatter.

There are two main categories of RFID systems: active RFID and passive RFID. Active RFID uses transponders that are powered by an on-board power source (e.g., a battery, etc.). Passive RFID systems utilize transponders that do not have their own internal power source but rather rely on the transmitted radio waves for self-energization. The present embodiments relate to passive RFID but the skilled person will know how to apply the principles of the present invention to active systems. RFID transponders may have sophisticated designs and usually consist of an antenna, an RFID IC chip, and sometimes an internal or external resonating capacitor. The IC usually stores several kilo-bits of data. Some ICs are read only, some are one-time-programmable (OTP) and some have read/write functions constructed with non-volatile memories such as EEPROM (electronically erasable and programmable read only memory) or FeRAM (Ferromagnetic random access memory). In contrast with bar-code labels, a competing technology for stock inventory and product identification, RFID transponders are generally considered to be nearly impossible to copy or duplicate. Also unlike bar-code readers, RFID systems can function well in environments containing dust, dirt, grime, oil, snow, darkness, and high humidity, environments where bar codes are hard to read accurately. In addition, RFIDs can read or read/write in non-line-of-sight applications, through clothing, wood and nonmetallic materials. These features allow RFIDs to displace bar-code systems in many commercial and industrial applications.

Currently, many models of RFID readers and transponders are made, and these devices are generally designed to operate in one of four frequency ranges: low frequency (approximately 125 kHz), high frequency (approximately 13.56 MHz), ultra-high frequency (approximately 915 MHz) and microwave (approximately 2450 MHz). Each of these frequency ranges is suitable for different applications. Low frequency readers are used in access control applications, and high frequency readers are used as smart card readers, for merchandise source tagging and electronic article surveillance (EAS) applications or electronic money exchange. UHF and microwave readers are used for longer distance and higher data rate asset tracking and asset management applications and are generally used with active transponders.

Turning specifically to passive transponders, and there are RFID systems that operate at 125 KHz, and 13.56 MHz (and also rarely at other frequencies) that can transfer information wirelessly between the reader device, or for that matter a writer device, and the transponder. The transponder is typically a mobile device such as a tag, label, card or similar, embedded on a product or a living animal or a human being. No physical contact is required between the device and the transponder in order for the transponder to carry out its function. Rather the transponder passes in proximity to the device at a reasonable reading distance, at which point the data is transferred.

As mentioned, the basis of the technology is backscatter, where the device and the transponder can be considered to be a transformer, with the device being the primary coil and the transponder the secondary coil. There is a magnetic and electromagnetic, but primarily Magnetic, coupling between the two coils. This is mutual inductance. Thus, any change in the load in the secondary will cause a change of voltage in the primary coil

RFID technology is used in products for identification and information exchange, and the products are used in applications such as access control, security system operation, vending machines and near-field communications with both public and private installations. The applications include use for access to a computer as well as time and attendance.

The operating range of the RFID, that is the distance between the device and the transponder in which data transfer takes place, is generally between 30mm and 120 mm, beyond which devices are considered as long range.

One use of RFID is for identification for example to control access to secure areas. Another is to identify oneself for making payments, including paying transportation tolls. Another use is for personnel management, where an RFID system can replace a traditional clocking in system. For these applications the devices are often installed outdoors and are thus susceptible to damage from the weather and also from attempts to vandalise the devices, for example by persons wishing to overcome security or avoid payment. That is to say, being security devices or devices protecting property or value, the ability to be resistant to attempts to bypass the security by breaking and opening the devices or by attempts to cheating the system is significant.

Now, due to the fact that the technology is based on RF, developers use materials that are non metallic, such as plastics materials. This is because metallic bodies would interfere with and disturb the RF (radio frequency magnetic fields and electrical fields) preventing any effective transmission at all or at best reducing the read range. The effect of the metal would be either to redirect the field or subdue the field, and could lead to a read range of less than 30 mm or even to an extent where physical contact is required.

The problem posed by metal is even more severe in the newer contactless technology based on 13.56 MHz, than the older technologies based on much lower frequencies such as 125 KHz. In the 13.56 MHz system, the wavelength in free space is about 22 m. This is much longer than the usual operating distance of several tens of millimeters. At these frequencies the reading range is firmly located in the near field. Consequently the wave does not propagate and the magnetic field predominates. Under these conditions the antenna behaves like a dipole and the inverse cube law is more applicable than the usual inverse square law.

Considering the problem posed by metal in general, RFID technology is based on Magnetic coupling. The antenna is better described as a loop, and the loop behaves very much as an inductor rather than a regular antenna. As operation is very close, very close being in the sense that the operating distance is much less than the wavelength, the usual interchange between magnetic and electrical fields that is typical of electromagnetic propagation does not occur, and the process of interest is purely magnetic. Most metals do not shield the magnetic field, in contrast to the electrical field, which they do shield and this is of course the basis of most metallic shielding. However when we have a changing magnetic field, and in high frequency RFID the field changes at 13.56 million times per second, a current loop is induced in conducting materials. The current loop is however unwanted as it is always in a direction that opposes and thus reduced the originating field. This is Lenz's law, which is a consequence of the law of conservation of energy. The effect is a reduction in the field that we call magnetic shielding. The usual way of reducing the magnetic shielding effect, commonly used in transformers, is to cut a small gap in the metal, breaking the circuit and thus preventing the current loop from flowing. Such a break causes the shielding to drop significantly.

It is noted that whilst most of the discussion relates to the high frequency application mentioned above, in actual fact the Near Field consideration is even more binding for low frequencies. For example at 125 KHz the wavelength is 3E8/125 KHz=2.4 Km, so the operating range of the RFID is even more inside the near field. However, the shielding problem is more severe at 13.56 MHz as the induced current is proportional to frequency by Faraday's law of induction.

Now one of the problems with using RFID for access technology is that the lock may need to be placed on metal doors on the like. U.S. Pat. No. 6,307,517 discloses a metal compensated radio frequency identification reader for low frequencies, in which the reader is housed so that the influence of its physical surroundings, including metal objects is minimized. A pre-compensation metal plate is placed at a distance from the antenna defined by a sponge filler, and the plate stabilizes the self-resonant frequency of the reader so that it remains substantially constant even in the presence of metal masses. The application is designed to be resilient to outside interference due to passing metal objects or to effects of local metal objects. As an example the device is designed so that it can be mounted on a steel door.

However, even with the above technology it is not possible to make the housing itself of metal. The use of metal to house the RFID reader would be advantageous as such a device would make it more difficult to damage the product and thus penetrate the system. Such a housing would also protect the unit from environmental and occasional accidental damage.

In the known art there is no way of keeping a metal housed product the same size as the corresponding plastic reader, and at the same time retain the range. In transformers it is well known to place an air gap in the metal core, to prevent loop currents from flowing, but a metal housing with such a gap would have its strength compromised.

It would also be desirable to retain field shape and direction but the moment metal is introduced into the product the field shape and direction are distorted.

There is thus a widely recognized need for, and it would be highly advantageous to have, an RFID device devoid of the above limitations.

### SUMMARY OF THE INVENTION

According to one aspect of the present invention there is provided an RFID device comprising a device body and an antenna integrally located with said device body, the device for operating with RFID transponders at a predetermined frequency, wherein:

said device comprises a metallic chassis about said device body,

said antenna is spaced by a space of at least one millimeter from said metallic chassis, and

said antenna is tuned to achieve resonance at said predetermined frequency at said integral location.

According to a second aspect of the present invention there is provided a method of manufacturing a secure RFID device comprising:

providing a metallic chassis,

providing RFID electronics within said chassis,

locating an antenna on an integrated structure on said chassis, said integrated structure including a spacer to distance said antenna from said chassis by at least one millimeter; and

tuning said antenna to resonate at a predetermined RFID operating frequency while located in said integrated structure.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows an automatically operated lock device based on an RFID reader according to a first preferred embodiment of the present invention;

FIG. 2 is an exploded diagram showing construction of the RFID components in the device of FIG. 1;

FIG. 3 is a cross section showing the construction of the components of FIG. 2 according to a preferred embodiment of the present invention;

FIG. 4 is a detail of FIG. 3;

FIG. 5 is a flow chart illustrating a process of manufacture of an RFID reader device with a metallic chassis, according to a preferred embodiment of the present invention;

FIG. 6 is a simplified diagram illustrating an arrangement for tuning an antenna in situ for use in a preferred embodiment of the present invention;

FIG. 7 is a simplified diagram illustrating a two loop antenna printed on a PCB for use in a preferred embodiment of the present invention; and

FIG. 8 is a simplified circuit diagram showing internal electronics of an RFID reader and transponder according to a preferred embodiment of the present invention.

### DESCRIPTION OF THE PREFERRED EMBODIMENTS

The present embodiments provide an RFID reader device which comprises a device body and an antenna integrally located thereon. The reader device comprises a metallic chassis about the body, the antenna is spaced by at least one millimeter from the metallic chassis, preferably between three and six millimeters and the antenna is tuned to achieve resonance at the desired transponder frequency from the integral location. That is to say tuning is adjusted to take account of a change in inductance due to the proximity of the metallic chassis. Use of metal in the chassis makes the reader device more secure.

It is pointed out that while the following description describes a reader device having a metal housing, an RFID system also includes a writer device that can write data to a transponder, and the transponder itself. It is usually the reader device which is located in a vulnerable location, and thus requires metal shielding. The writing device nevertheless may in certain applications also require the same level of protection, and in certain cases so may the transponders, so that references to the reader device should also be understood to extend to the writing devices and transponders.

The above construction provides improved performance of the reader/writer device when the transponder device itself is constructed using metal. The embodiments provide an anti-vandal and environmentally sturdy construction to provide an answer to physical attacks and the environmental conditions for outdoor installations.

The above construction permits the antenna to be integrally located in association with a homogenous metal surface, and still give useful performance under adverse conditions. Certain embodiments may even substantially increase the effective range as compared with similar devices.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

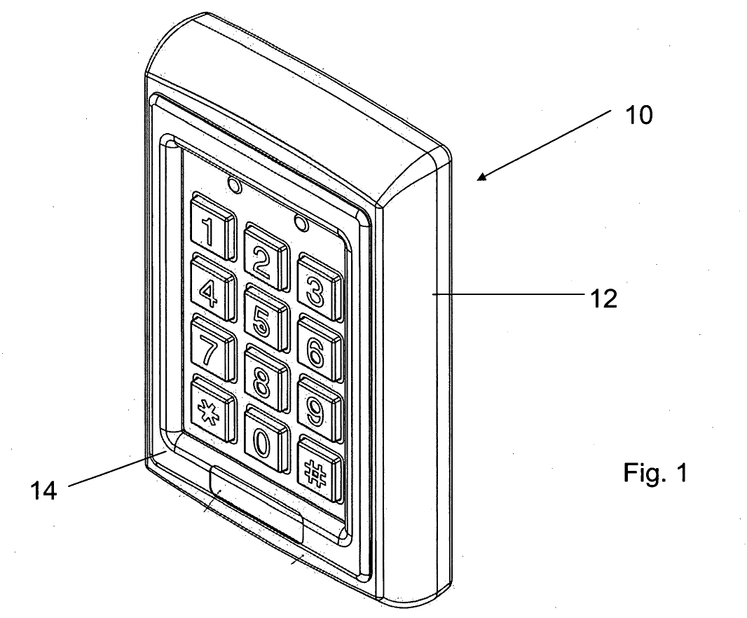

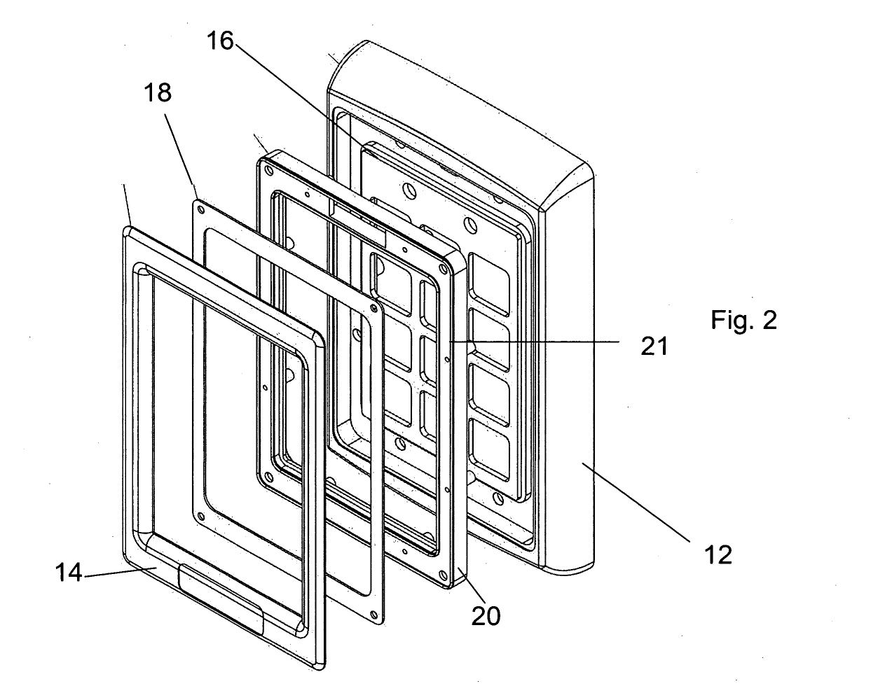

Reference is now made to FIG. 1, which shows an RFID reader—based secure entry device 10 comprising a device body 16 (FIG. 2) housed within a chassis 12. The reader device is intended for mounting around a secure area, for example in association with a security door. The proximity of the correct transponder opens the door which otherwise is kept locked. As will be explained chassis 12 comprises metal to make the reader device 10 secure against vandalism and the elements. Cover 14 hides an antenna integrally located with the device body. The cover 14 is mounted and mechanically protected in a reasonable way by the chassis 12 without any large openings or breaking of the homogenous surface of the chassis, thereby strengthening the device as a whole and providing resilience to attack and damage.

Reference is now made to FIG. 2, which is an exploded diagram illustrating the integral construction for location of the antenna. The integral construction comprises outer cover 14 which fits over antenna part 18 which in turn is located over frame shaped spacer 20. Antenna part 18 is enclosed in the frame of frame-shaped spacer 20 within a recessed area 21. The frame-shaped spacer 20, comprising recess 21, may be made of a plastics material, and the antenna part 18, which is the component that produces and shapes the field for RFID, fits snugly within the recess. The cover 14 protects the antenna part 18 in its mounted position, that is sandwiched between the Frame 20 and the protective cover 14.

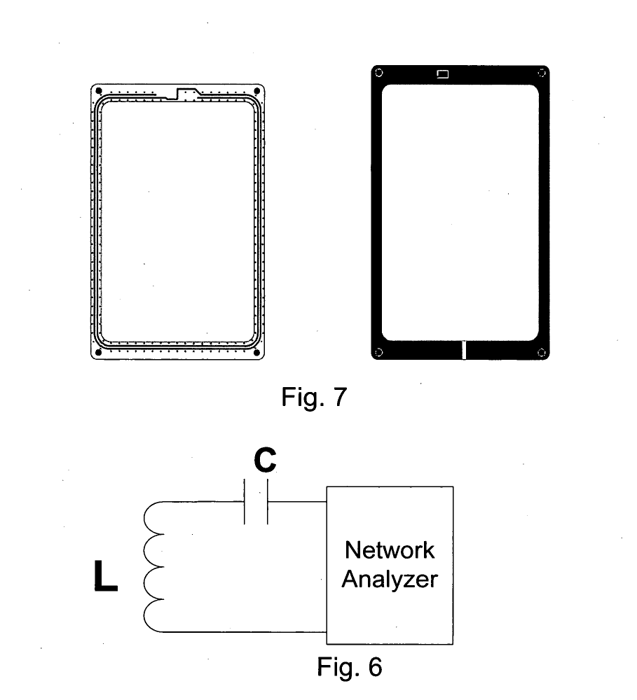

Spacer 20 ensures a gap of typically a few millimeters between the antenna and chassis 12 which, as mentioned is preferably metallic. The spacing is at least one millimeter, but distances of two, three, four, five, six, seven, eight and nine millimeters may all be considered. The antenna part 18 is preferably a PCB in the form of a rectangle around the periphery of which a conductive track is printed. The track runs typically twice around the periphery to form a spiral as shown below in FIG. 6. A printed antenna is preferable to an actual wound wire coil because the electrical properties are more exactly repeatable for mass production.

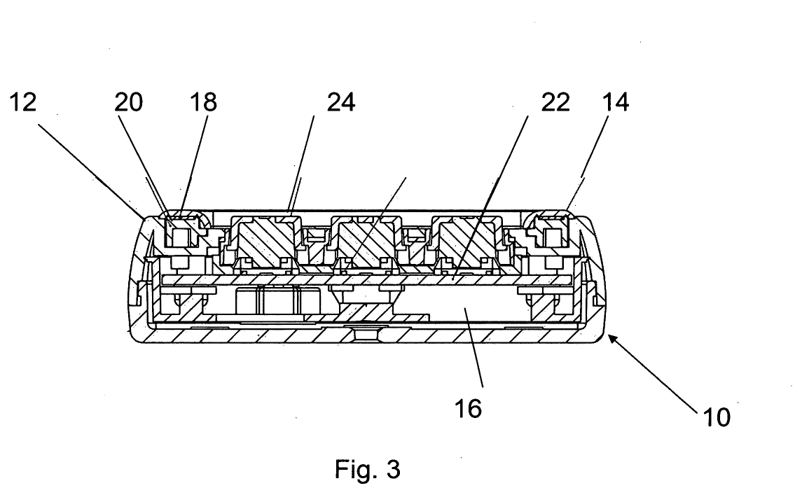

FIG. 3 is a cross section of device 10 showing the integral construction. Cover 14 fits over antenna part 18 and slots securely into chassis 12. Cover 14 is in fact plastic and preferably strong plastic but is constructed so as to be very difficult to remove because of the chassis. Spacer 20 underlies the antenna 18 to define a separation between the antenna and the chassis as explained. Main PCB 22 is part of the device body 16 and mounts electronics for supporting the reading operations, and possibly other operations of the device such as manual opening of the lock via a code number. Keypad buttons 24 allow a user interface for such a purpose or for any other need.

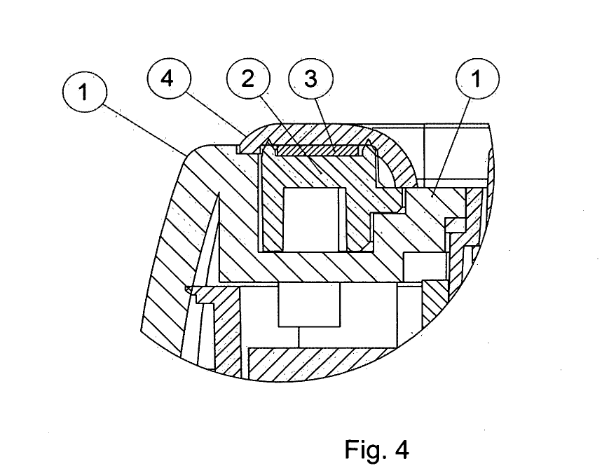

FIG. 4 is a detail of FIG. 3 and shows more clearly how the antenna part 18 is held firmly between spacer 20 and cover 14, while both cover 14 and spacer 20 slot into chassis 12. A distance is thus defined between the antenna part and the chassis both in the horizontal and vertical planes as per the figure.

In use the device 10 is operated with RFID transponders at a predetermined frequency which is typically 13.56 MHz, although low frequency devices may be used at 125 KHz. The antenna is tuned to achieve resonance at the predetermined frequency when it is placed at the integral location within the cover and inside the chassis. More particularly, the very location of the antenna inside the chassis brings about a reduction in its inductance due to the presence of metal, thus changing its resonant frequency or detuning the circuit. Thus the antenna is compensated for the reduction in inductance by addition of a predetermined fixed capacitance value, so that resonance returns to the predetermined frequency.

For any given design the capacitance required to restore resonance is determined at the design stage, and this capacitance is simply manufactured into the circuit. However a certain amount of fine tuning may be required for each individual device to compensate for manufacturing tolerances. To this end a variable capacitor may be included for allowing fine tuning of the antenna in situ at the integral location following manufacture of the device.

In one embodiment, the antenna, which as explained is preferably a printed antenna, printed on a PCB substrate, is located between two groundplanes to provide electrostatic shielding. The groundplanes may be located at a distance, in the order of a millimeter, to improve effectiveness, as is known in the art.

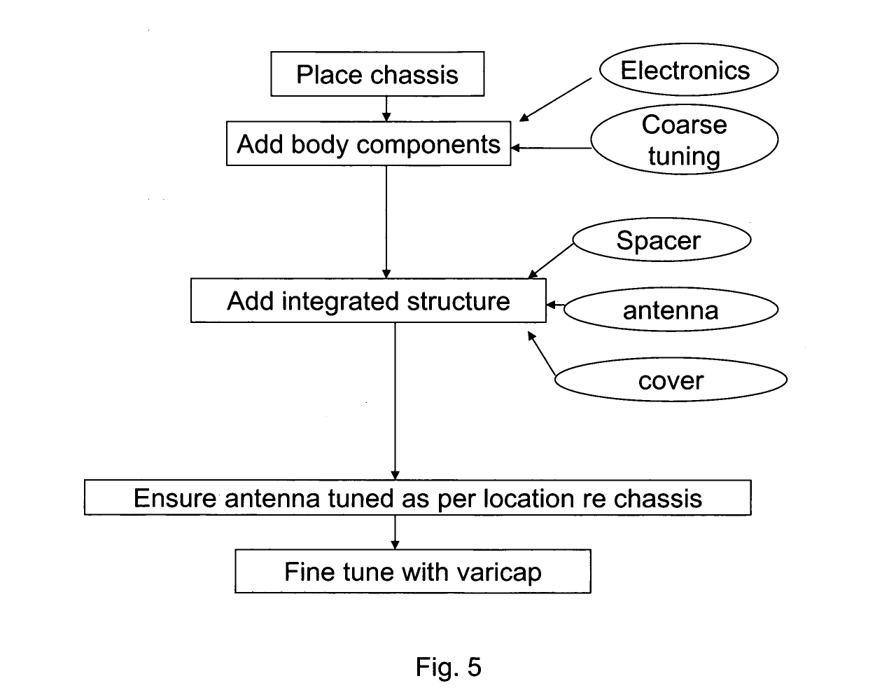

Reference is now made to FIG. 5, which is a simplified flow chart illustrating a method of manufacture of the RFID reader device described above. The manufacturing process comprises providing a metallic chassis, placing RFID reader electronics within the chassis, and then adding an integrated structure as discussed above in which the spacer, the antenna and the cover are fitted within the chassis in such a way that the antenna is spaced from the metal of the chassis. The electronics is arranged with capacitance to compensate for the reduced inductance caused by the proximity of metal to the antenna, so that to at least a coarse level the antenna is tuned to resonate at the intended operating frequency from its position within the integrated structure.

The tuning of the device may then include fine tuning using a variable capacitor once the antenna is in situ at the integral location in a manufactured device. In this way manufacturing tolerances can be overcome.

As explained, the metal chassis interacts with the magnetic field to attenuate and distort the field. The field thus tends to induce a loop current that opposes the initial field, thereby canceling inductance. This is the well known Lenz's law. The effect is to greatly reduce the field strength. In effect the present embodiments are the equivalent of placing another, smaller, coil in parallel with the antenna coil.

The RFID reader with the antenna in effect form an LC tuned circuit, and the effect of the presence of the metal is to reduce the value of L, and thus change the resonant frequency, as explained. As a first approximation to solving the problem introduced by the presence of the metal it is possible to retune the circuit to resonate when it is already in place in the metal chassis. The location within the chassis was found to cause the L value to drop by as much as 75%. By changing the serial resonant capacitor the circuit was returned to resonance at the operating frequency. However, the inductance is, effectively, much smaller and the Magnetic field generated is lower.

Reference is now made to FIG. 6 which shows a simple LC circuit 30 connected to a network analyzer 32. The L component of the LC circuit represents the antenna coil itself. Tuning of the reader is carried out while the antenna integral assembly discussed above is placed in chassis 12. The antenna coil (L) is connected to network analyzer 32 and a resonant capacitor is placed in series. The capacitor value is changed until the required resonant frequency is obtained at the highest possible value of Return Loss (RL). The capacitor value is now retained for manufacture of individual devices.

The printed PCB with the antenna coil is shown in FIG. 7. The next step is to move the coil, as printed on the antenna PCB, a few millimeters from the recessed chassis bottom. Here it was found experimentally that this small change in position has a dramatic effect on the field strength produced at resonance and therefore the range of the RF interaction that the reader is capable of. That is to say the field strength is increased by distancing the newly retuned antenna a few millimeters from the chassis.

FIG. 7 shows the internal track of the printed PCB antenna. In an embodiment the substrate is FR4, a strong and flame resistant substrate that also adds to the security of the device. The substrate may be sandwiched between two ground planes, and the ground planes then serve as an electro-static shield, preventing electrostatics but not interfering with the required magnetic coupling. Care is preferably taken to leave a small gap in the shielding so as to prevent any loop currents that would cause magnetic shielding, as previously explained in this paper.

As explained with reference to FIG. 6, the coil is realized by a single printed track of two turns on a regular PCB substrate. The normal inductance of such an antenna would be expected to be up to 1 uH at 13.56 MHz, however this is reduced by up to 75% due to the effects of the metal chassis as explained. The antenna is sandwiched between the insulating frame-shaped spacer 20 and protective cover 14 as explained.

The spacer serves to distance the coil from the bulk of the reader body, since the bulk includes metal, particularly but not exclusively in the chassis. The metal would otherwise reduce the magnetic field, as explained. The PCB antenna part 18 preferably comprises two solder points that allow the coil to be electrically connected to its driver circuit which is housed in the main PCB 22 inside the body 16.

The use of a printed coil for the antenna improves reliability and repeatability in the coil parameters, in particular inductance, L and quality factor, Q. The traditional wound antenna would be far less reproducible and therefore give rise to problems with manufacturing tolerances. The PCB solution also allows precise positioning of the antenna coil relative to the metal case. Thus the positioning itself becomes a manufacturing parameter which may be precisely controlled.

The above embodiments describe a contactless reader housed in a metallic chassis, allowing the card reader to be physically very robust and to be able to withstand attacks that might otherwise render the system inoperative. This is significant as such contactless readers are often placed in the outdoors in unsupervised environments, and problems caused by the tendency of the metal housing to reduce the operating range due to its shielding of the magnetic field are overcome.

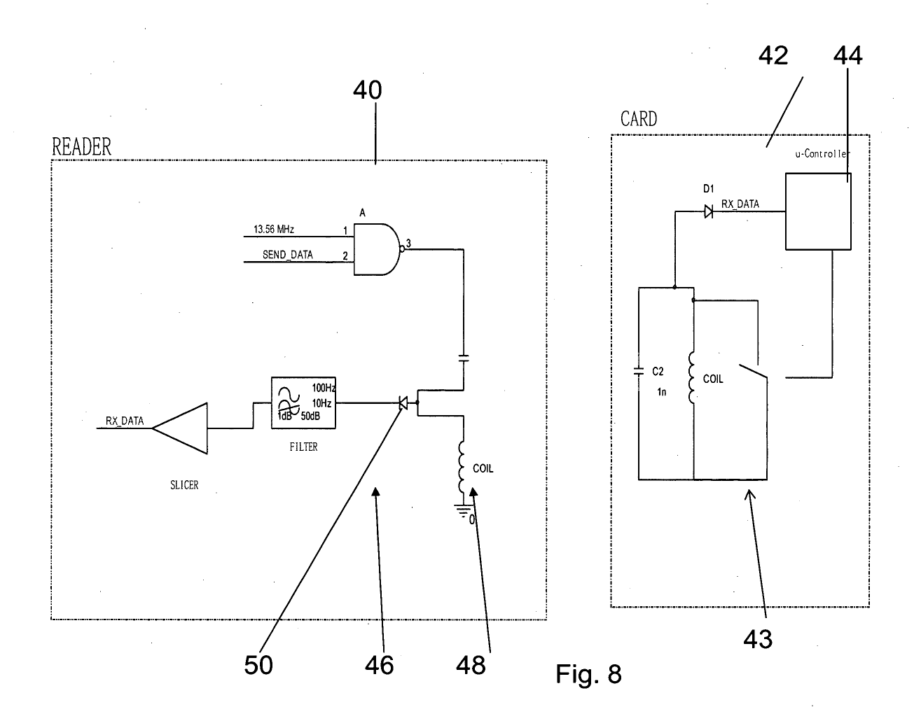

The basis of Contactless technology is backscatter. Referring now to FIG. 8, 13.56 MHz reader 40 and contactless card or transponder 42 can be considered to be a transformer, the reader being the primary coil and the card the secondary coil. There exists a magnetic coupling between the two coils, the mutual inductance. Due to the mutuality of the system, any change in load in the secondary coil causes a corresponding change in the primary coil. However firstly the coupling is very small, and secondly the coupling is of a magnetic nature since the distances involved are much smaller that the wavelengths of the signals in the range in question. A signal based on magnetic coupling falls at a very steep rate that may be approximated by a

$$\frac{1}{{r}^{3}}$$

law, where r is the distance.

The decisive factor that fixes the operating range is the ability of the reader to induce a voltage in the card that enables the on-card electronics to function. Card 42 rectifies the signal that it receives from the reader in its own resonant circuit 43. As soon as the electronics is able to function then the back scatter function works. The card uses its data to modulate the carrier signal and the card may talk back to the reader.

Initially the reader produces a 13.56 MHz carrier that is modulated by on-off Keying, that is OOK modulated. This induces a voltage in the coil of the card that is used to power microcontroller 44 and other electronics. The card is then able to demodulate the OOK data that are sent to it. This simple modulation is performed in the reader by simply switching on and off the 13.56 MHz carrier at the data rate.

In response the card switches in a load that causes the amplitude in the reader coil to vary slightly. In effect this switched load is “reflected” on to the primary coil by the transformer action. As the coupling is very small the change in the amplitude in the reader is quite small, often much less than 1% modulation depth. A simple diode detector 46, based on diode 50, is used to extract the envelope. Some band pass filtering is used and the raw date is recovered by a data slicer that is implemented by a comparator. The data are typically sent using a type of Manchester II encoding within the OOK. In the Manchester II encoding a “1” is 8 cycles of the sub carrier (˜857 KHz) followed by 8 cycles of no modulation's. A “0” is the same but in reverse order.

The reader further comprises a 13.56 MHz driver, not shown, that resonates a serial LC circuit 48. The L is in fact the antenna coil discussed inter alia in respect of FIG. 6. The larger the area of the coil the greater the field strength and therefore the range.

The protocol consists of an 854 KHz sub carrier and a 94 KHz Manchester encoded data rate.

It is expected that during the life of this patent many relevant devices and systems will be developed and the scope of the terms herein, particularly of the term RFID, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An RFID device comprising a device body and an antenna integrally located with said device body, the device for operating with RFID transponders at a predetermined frequency, wherein:
said device comprises a metallic chassis about said device body,
said antenna is spaced by a space of at least one millimeter from said metallic chassis, and
said antenna is tuned to achieve resonance at said predetermined frequency at said integral location.

2. The device of claim 1, comprising a predetermined fixed capacitance value connected to said antenna to achieve said tuning.

3. The device of claim 2, further comprising a variable capacitor for allowing fine tuning of said antenna in situ at said integral location.

4. The device of claim 2, further comprising a spacer for defining said space between said antenna and said metallic chassis.

5. The device of claim 1, wherein said predetermined frequency is a radio frequency being in at least one of the low frequency range and the high frequency range.

6. The device of claim 5, wherein said radio frequency is substantially 125 KHz or substantially 13.56 MHz.

7. The device of claim 1 wherein said space is at least two millimeters or at least three millimeters, or at least four millimeters or at least five millimeters or at least six millimeters or at least seven millimeters or at least eight millimeters or at least nine millimeters.

8. The device of claim 4, wherein said antenna is integrally located between said spacer and an outer cover.

9. The device of claim 8, wherein said outer cover is configured to fit over said antenna and be located in said metallic chassis.

10. The device of claim 1, wherein said antenna is a printed antenna, printed on a PCB substrate, said substrate being located between two groundplanes to provide electrostatic shielding.

11. The device of claim 1 being an RFID reader device.

12. A method of manufacturing a secure RFID device comprising:
providing a metallic chassis,
providing RFID electronics within said chassis,
locating an antenna on an integrated structure on said chassis, said integrated structure including a spacer to distance said antenna from said chassis by at least one millimeter; and
tuning said antenna to resonate at a predetermined RFID operating frequency while located in said integrated structure.

13. The method of claim 12, wherein said integrated structure comprises a cover fitting over said antenna and located within said metallic chassis.

14. The method of claim 12, wherein said tuning comprises providing a predetermined fixed capacitance value connected to said antenna to achieve said tuning.

15. The method of claim 14, wherein said tuning further comprises providing a variable capacitor and fine tuning of said antenna in situ at said integral location using said variable capacitor.

16. The method of claim 12, wherein said predetermined frequency is a radio frequency being in at least one of the low frequency range and the high frequency range.

17. The method of claim 16, wherein said radio frequency is substantially 125 KHz or substantially 13.56 MHz.

18. The method of claim 12, wherein said antenna is distanced by at least two millimeters or at least three millimeters, or at least four millimeters or at least five millimeters or at least six millimeters or at least seven millimeters or at least eight millimeters or at least nine millimeters.

19. The method of claim 12, comprising locating said antenna between said spacer and an outer cover.
